(19) United States
(12) Patent Application Publication
(10) Pub. No.: US 2014/0084059 A1
(43) Pub. Date: Mar. 27, 2014

(54) UNIVERSAL INTERACTIVE SMART CARD DEVICE

(71) Applicants: Joseph Sierchio, Valatie, NY (US); Meetesh V. Patel, Ellicott City, MD (US)

(72) Inventors: Joseph Sierchio, Valatie, NY (US); Meetesh V. Patel, Ellicott City, MD (US)

(21) Appl. No.: 14/116,848

(22) PCT Filed: May 11, 2012
(86) PCT No.: PCT/US12/37404

§ 371 Date: Nov. 11, 2013

Related U.S. Application Data
(60) Provisional application No. 61/485,084, filed on May 11, 2011.

(51) Int. Cl. G06Q 20/34; G06K 19/077

(52) U.S. Cl. CPC G06Q 20/3572; G06K 19/07707
USPC 235/380; 235/492

(57) ABSTRACT

A secure, universal, and interactive smart card device including a display, an interface device, a security device, and a storage device. The card device can include an on-board power supply for powering the display, interface device, security device, and storage device.

### CROSS-REFERENCE TO RELATED APPLICATIONS

The present invention claims the benefit under 35 U.S.C. §119 of U.S. Provisional Patent Application No. 61/485,084, filed May 11, 2011, and entitled “UNIVERSAL INTERACTIVE SMART CARD DEVICE”, the entire contents of which are incorporated herein by reference.

### FIELD OF THE INVENTION

The present invention relates to a secure, universal, and interactive smart card device, and more specifically, to a secure, universal, and interactive smart card for a plurality of vendors having a scrolling device and a biometric reader.

### BACKGROUND OF THE INVENTION

Vendors, retailers, department stores, consumer and business service providers, and financial service providers (hereinafter generally referred to as “vendors”) commonly provide users with membership cards, rewards cards, vendor-provided credit cards, or the like, that offer credit, promotional discounts/coupons, specials, deals, etc. or that accumulate rewards points or travel miles toward promotional discounts, specials, deals, cash rebates, product rebates, free products/services, etc. Vendors may offer such rewards, etc. to encourage consumer spending and increase sales or to obtain or track consumer spending habits, locations, etc.

A consumer typically will carry a plurality of credit cards issued by various vendors to pay for purchases along with any number of membership cards, rewards cards, etc. The plurality of cards can be cumbersome and inconvenient for the consumer to carry, for example, in a purse or wallet, in which space is limited.

Ordinarily, the consumer will present the particular vendor's membership card, rewards card, etc. at the point of sale to obtain any available or current benefits, such as rewards points, miles, discounts, coupons, etc., and then pay for the corresponding purchases or services using a credit card (e.g., bank issued credit card).

In this instance, the consumer may need to present a plurality of cards for a single transaction. Thus, each transaction can be time-consuming for both the consumer and the vendor, for example, resulting in longer lines and wait times for other consumers. Vendors may need to provide additional cashier lines, staff, etc. to attempt to minimize the inconvenience to the consumers.

If a consumer is not carrying the particular vendor's reward/membership card at the point of sale, then the consumer commonly may be asked to verbally disclose a telephone number or other personal information to the cashier such that the cashier can look up the consumer's information. This can be time consuming to both the consumer and the vendor, and al so may require the user to verbally disclose personal information to the cashier, which may also be overheard by other consumers. These inconveniences to the consumer may discourage consumers from using or taking advantage of all available benefits of their cards, which correspondingly may reduce the desired sales by vendors and/or reduce the amount of data collected by the vendor with respect to consumer spending habits, purchase locations, etc.

In other instances, a consumer may present a vendor-issued credit card, which includes a membership or rewards program, etc. at the point of sale at the particular vendor, in order to pay for the corresponding purchases or services and simultaneously obtain any available or current benefits, such as rewards points, miles, discounts, coupons, etc. In this instance, if the consumer is not carrying the particular vendor's credit card, the consumer may be able to complete the purchase with another credit card but will not be able to obtain the membership or rewards points from the vendor for that purchase.

In still other instances, the vendor may accept only a particular credit card, such as a vendor-issued credit card or a credit card issued by a particular vendor (e.g., such as a wholesale warehouse that accepts only cards issued directly by the wholesale warehouse or one type of credit card, such as one of American Express, Visa, MasterCard, Discover Card, etc.). In this instance, if the consumer is not carrying the particular vendor's credit card or a credit card accepted by that particular vendor (e.g., the consumer is carrying American Express, but the vendor only accepts vendor-issued credit cards or VISA and MasterCard), then the consumer may not only be unable to obtain the membership or rewards points, but the consumer will not be able to complete the transaction. Thus, the consumer will not be able to purchase the goods or services and the vendor will lose the revenue from this potential transaction.

Some conventional smart cards (e.g., smart card, chip card, or integrated circuit card (ICC)), and devices have attempted to provide a multi-application smart card or data card that can be substituted for a plurality of single-application cards, such as vendor credit cards. Many conventional smart cards may require the vendor to purchase and use specialized card readers or software in order to accept the smart cards, which may increase costs to vendors and correspondingly limit the number of participating vendors. The consumer may need to interact with a card reader or data port to select a particular application for the card, such as a particular credit card vendor.

### SUMMARY OF THE INVENTION

These problems and others are addressed by the present invention, a first exemplary embodiment of which includes a secure, universal, and interactive smart card device comprising a display, an interface device, a security device, and a storage device. The card device can include an on-board power supply for powering the display, interface device, security device, and storage device.

In this manner, this exemplary embodiment can provide a secure, universal, interactive credit card that can be used by a consumer in any location and that permits a user to interact with the card (e.g., directly with the card) to selectively attribute the use of the card to a particular vendor out of a plurality of available vendors, after which the card can be used by the consumer in the same manner as a conventional credit card, rebate card, rewards card, membership card, etc. The exemplary embodiments can provide consumer-based or card-based selectivity, as opposed to vendor-based selectivity or card reader-based selectivity.

Accordingly, in an instance in which a vendor provides membership or rewards points, etc., and the consumer is not carrying that particular membership or rewards card, the consumer will still be able to complete the purchase with another credit card while obtaining the membership or rewards points from the vendor for that purchase.

Similarly, in an instance in which a vendor accepts only a particular credit card with a membership or rewards program, and the consumer is not carrying that particular credit card, the consumer will still be able to complete the purchase and obtain the membership or rewards points from the vendor for that purchase.

Furthermore, in an instance in which a vendor accepts only a particular credit card, and the consumer is not carrying that particular credit card, the consumer will still be able to complete the purchase with another credit card and obtain any available the membership or rewards points from the vendor for that purchase, and hence, the vendor will not lose the revenue from this transaction.

In operation, a user carries the exemplary secure, universal, interactive smartcard in place of one or more of the user's conventional credit cards, membership cards, rebate cards, rewards cards, or the like. At the point of sale, the user can activate the card, for example, by using the security device. For example, the user may swipe a finger or thumb over a biometric fingerprint reader to authenticate the user's identity and activate the card. The user may then use the interface device, such as a scroll device, to navigate or scroll through a list of available vendor applications stored on the card. The display of the card may display a variety of information with respect to each vendor of a plurality of vendors stored in the storage device of the card, such as the vendor name, account number, etc., such that the user can verify which vendor application is being selected. When the desired vendor information is shown on the display, the user can select the vendor application, for example, by affirmatively selecting the vendor using a select feature (i.e., a discrete select feature), by again verifying the user's identity using the security feature), or by simply using the card in a manner similar to a conventional card, such as swiping the card, scanning the card, using a contactless feature, such as an RFID feature, of the card, or the like.

In some instances, a user may need to hand the secure, universal, interactive smartcard to a vendor, such as a waiter, at the point of sale to complete a purchase for goods or services. In another embodiment, the secure, universal, interactive smartcard can include a lock device or feature that prevents the display from displaying the selected card number and data, other non-selected card numbers or data, and/or other information stored on the smartcard, etc.

For purposes of this disclosure, a lock device or feature includes a hardware or software device (e.g., a hardware device or a device programmed to perform a locking function) that prevents one or more types or items of data (e.g., card numbers, expiration dates, security codes, user information, etc.) that is stored on the card (e.g., on a memory device, magnetic strip, etc.) from being displayed on the display of the card, selectable for display on the display, selectable or downloadable from the card (for example, by swiping a magnetic strip of the card, transferring data using radio frequency, Bluetooth, or other wireless means), and/or being displayed, read, downloaded from the card in any way. In other embodiments, the lock device or feature can include a hardware or software device (e.g., a hardware device or a device programmed to perform a locking function) that prevents one or more types or items of actual data (e.g., actual card numbers, expiration dates, security codes, user information, etc.) stored on the card (e.g., in a storage device, magnetic strip, etc.) from being displayed on the display of the card, selectable for display on the display, selectable or downloadable from the card (for example, by swiping a magnetic strip of the card, transferring data using radio frequency, Bluetooth, or other wireless means), and/or being displayed, read, downloaded from the card in any way, and instead, permits only encrypted data, fake or so-called “dummy” or “ghost” data, or random data to be displayed, readable, or downloadable from the card such that the actual user information remains confidential. For example, in an embodiment, the secure, universal, interactive smartcard can include an encryption feature that encrypts any or all of the data stored on the smartcard such that only encrypted in formation is displayed on the display or downloadable, transferable, etc. from the smartcard, not the actual data stored on the card. In still other embodiments, some or all of the data stored on the card (e.g., on a storage device, magnetic strip, etc.) can be stored in encrypted form. The encryption key for decrypting the data can be locally stored on the card, require user input or biometric confirmation, or be remotely located from the card, such as at one or more of the credit card companies, card or membership issuer, etc., for example, for pairing the transaction with the user's account and/or authorizing the transaction, among other things. The lock device or feature also can include a hardware or software device (e.g., a hardware device or a device programmed to perform a locking function) that prevents one or more types or items of data (e.g., card numbers, expiration dates, security codes, user information, etc.) or code (e.g., spyware, malware, etc.) from being transferred, programmed, or uploaded, etc. onto the smartcard.

In this way, a user can hand the secure, universal, interactive smartcard to a vendor, such as a waiter, at the point of sale to complete a purchase for goods or services without fear of compromising data or information on the card. Moreover, these features can improve security and reduce or eliminate a risk of unauthorized use of the smartcard, for example, in an event of a lost card, stolen card, or other unauthorized attempt to use the card.

The lock device feature can be, for example, an auto-lock device or feature that automatically locks the card after the user selects the vendor application without additional user intervention. The lock device or feature also can be activated by an affirmative step performed by the user, such as performing an additional swipe of the user's finger or thumb over the biometric fingerprint reader to lock the card. The lock feature also can be a user selected option such that the user may select between an auto-lock feature and an affirmative step to lock the card. One of ordinary skill in the art will recognize that other lock devices and features are contemplated within the spirit and scope of the invention, such as entering a numeric or alphanumeric password or code to lock and/or unlock the card, data on the card, data displayed on the card, data readable from the card, data transferable from the card, and/or data transferable or programmable onto the card.

In operation, the vendor's card reader can scan or receive the account information for the particular selected vendor application in the same manner as if the user was using a conventional vendor card, credit card, rebate card, membership card, rewards card, etc., and thus, may not require any additional or specialized equipment or processes on the vendor side.

If the user desires to switch to a different vendor application of the plurality of available vendor application stored in the storage device of the card, such as a different rewards card or credit card, the user may again activate the card using the security device and then select another vendor application out of the plurality of vendor applications stored in the storage device on the card.

In this manner, this exemplary embodiment can provide a secure, universal, interactive credit card that can be used by a consumer in any location and that permits a user to interact with the card (e.g., directly with the card) to selectively attribute the use of the card to a particular vendor out of a plurality of available vendors, after which the card can be used by the consumer in the same manner as a conventional credit card, rebate card, rewards card, membership card, etc. The exemplary embodiments can provide consumer-based or card-based selectivity, as opposed to vendor-based selectivity or card reader-based selectivity.

In other embodiments, a secure, universal, interactive credit card according to the embodiments can be enrolled in a membership or service, such as a payment processing service.

In operation, similar to the aforementioned exemplary embodiment, a user carries the exemplary secure, universal, interactive smartcard in place of one or more of the user's conventional credit cards, membership cards, rebate cards, rewards cards, or the like. At the point of sale, the user can activate the card, for example, by using the security device. For example, the user may swipe a finger or thumb over a biometric fingerprint reader to authenticate the user's identity and activate the card. The user may then use the interface device, such as a scroll device, to navigate or scroll through a list of available vendor applications stored on the card. The display of the card may display a variety of information with respect to each vendor of a plurality of vendors stored in the storage device of the card, such as the vendor name, account number, etc., such that the user can verify which vendor application is being selected from the storage device of the card. When the desired vendor information is shown on the display, the user can select the vendor application, for example, by affirmatively selecting the vendor using a select feature (i.e., a discrete select feature), by again verifying the user's identity using the security feature), or by simply using the card in a manner similar to a conventional card, such as swiping the card, scanning the card, using a contactless feature, such as an RFID feature, of the card, or the like.

In this embodiment, the vendor's card reader can scan or receive the account information for the particular selected vendor application, for example, as an ordinary transaction using a card issued by the payment processing service. The card may transmit an account number for the payment processing service along with particular additional information, such as a suffix or prefix, which corresponds to the selected vendor application displayed on the card. This additional information can be used to inform the payment processing service of the appropriate account to charge the transaction. Again, this embodiment may not require any additional or specialized equipment or processes on the vendor side.

If the user desires to switch to a different vendor application of the plurality of available vendor application stored in the storage device of the card, such as a different rewards card or credit card, the user may again activate the card using the security device and then select another or different vendor application out of the plurality of vendor applications stored in the storage device on the card. In this embodiment, a vendor card reader can scan or receive the same account number for the payment processing service along with different additional information, such as a different suffix or prefix, which corresponds to the newly selected vendor application on the card. This additional information can be used to inform the payment processing service of the transaction for the newly selected vendor.

In this manner, this exemplary embodiment can provide a secure, universal, interactive credit card that can be used by a consumer in any location and that permits a user to interact with the card (e.g., directly with the card) to selectively attribute the use of the card to a particular vendor out of a plurality of available vendors, after which the card can be used by the consumer in the same manner as a conventional credit card, rebate card, rewards card, membership card, etc. The exemplary embodiments can provide consumer-based or card-based selectivity, as opposed to vendor-based selectivity or card reader-based selectivity. Additionally, this embodiment can maintain the information with respect to the vendor applications, such as account numbers, expiration dates, etc., entirely confidential from the vendor or anyone involved in the transaction, other than the payment processing service. The vendor may only be given knowledge of the user's account number for the payment processing service, but no information on the actual vendor account to which the transaction is being attributed. In other embodiments, some or all of the information (e.g., account number, etc.) may be maintained in encrypted form throughout the entire process. Alternatively, only randomly generated data may be displayed or available. The card may be configured to encrypt the account number, for example of the payment processing service, such that only an encrypted or ghost account number is known to the vendor. The encrypted account number may be based on the user's account number for the payment processing service and the selected vendor application and/or information particular to the card or the authorized user such that the payment processing service can decrypt the transaction data and attribute the transaction to the particular application on the card that was selected by that particular user.

In other embodiments, the card may be configured to display information with respect to one or more vendor applications on the card. For example, if the user desires to make a telephone or on-line purchase, the user can activate the card, for example, by using the security device. The user may then use the interface device, such as a scroll device, to navigate or scroll through a list of available vendor applications stored on the card. The display of the card may display a variety of information with respect to each vendor of a plurality of vendors stored in the storage device of the card, such as the vendor name, account number, etc., such that the user can verify which vendor application is being selected from the storage device of the card. When the desired vendor information is shown on the display, the user can obtain the desired account information for the selected application and use the card to make a telephone or on-line transaction in a manner similar to a conventional card.

In another example, if the user desires to access information with respect to a particular vendor application stored on the card, such as health or auto insurance information, roadside assistance information, customer service information for a particular vendor, etc., the user can activate the card, for example, by using the security device. The user may then use the interface device, such as a scroll device, to navigate or scroll through a list of available vendor applications stored on the card. The display of the card may display a variety of information with respect to each vendor of a plurality of vendors stored in the storage device of the card, such as the vendor name, account number, etc., such that the user can verify which vendor application is being selected from the storage device of the card. When the desired vendor information is shown on the display, the user can obtain the desired account information for the selected application from the card in a manner similar to reading the information from a conventional card.

Similarly, if the user desires to access information with respect to a particular vendor application stored on the card, such as an image of the user's signature, a photograph of the user, or other means for confirming the identity of the user, the user can activate the card, for example, by using the security device. The user may then use the interface device, such as a scroll device, to navigate or scroll through a list of available vendor applications or information stored on the card. The display of the card may be used by the user to display the desired identification information such that the user can show the identification information to verify or confirm the cardholder's identity to a vendor of a vendor application stored on the card, or to validate or confirm the cardholder's identify for other unrelated applications that are not associated with the applications stored on the card, such as to validate or confirm the cardholder's identify to law enforcement personnel, to obtain admission to a secure area (e.g., apartment or office building, parking garage, government facility), to complete unrelated transactions such as transactions using personal checks, to obtain admission to an event or concert requiring a ticket or reservation, etc.

The exemplary embodiments also include exemplary methods of providing consumer-based or card-based selectivity according to the aforementioned embodiments, as opposed to vendor-based selectivity or card reader-based selectivity.

The exemplary embodiments of the smartcard can be configured to use a vendor's existing hardware. In other embodiments, the smartcard can be configured to use only dedicated hardware distributed by a smartcard provider. In still other embodiments, the smartcard can be configured to selectively use a vendor's existing hardware and/or dedicated hardware distributed by a smartcard provider, thereby improving the universal use and/or acceptance of the smartcard at various vendors.

In another exemplary embodiment, the smartcard can be configured such that a user can add data (such as credit card data, etc.) to the card or remove data from the card. For example, the card can include one or more of a scanner device (e.g., camera with scanning software), a near-filed communication enabled device, a magnetic strip reader, a radio frequency transmitter/receiver, Bluetooth transmitter/receiver, or other wireless communication device, a data cable (e.g., USB, etc.), or other means for programming or uploading/downloading data to/from the card (e.g., via email, text, etc.).

In another exemplary embodiment, the smartcard can be configured such that data is stored on a storage device of the smartcard and only transferred to, or programmed onto, the magnetic strip upon being selected by the user. The magnetic strip can be permanently fixed to the smartcard, or alternatively, can be an “add-on” device that is selectively connected to the smartcard. The magnetic strip can be programmable by an on-board device of the card, or using another, external device. In other embodiments, the magnetic strip can include a plurality of data or data sets (e.g., a plurality of card data, numbers, etc.) that is selectable using, for example, a key, code, password, decryption key, etc. in operation, a part or all of the data on the magnetic strip may be read by a vendor's card reader (or alternatively, by a dedicated card reader device provided by the smartcard issuer) and only the data corresponding to the user selected account, or key, code, password, decryption key, etc. provided by the user in the transaction, can be authorized for the transaction, decrypted for the transaction, etc.

In another exemplary embodiment, the smartcard can be configured such that data is stored using cloud services (i.e., data is stored on a remote server) rather than on the storage device of the smartcard and only transferred to the smart card, for example, upon being selected by the user.

Other features and advantages of the present invention will become apparent to those of ordinary skill in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 illustrates a schematic block diagram of an exemplary card according to an embodiment of the present invention.

FIG. 2 illustrates a front plan view of an exemplary card according to an embodiment of the present invention.

FIG. 3 illustrates a rear plan view of an exemplary card according to an embodiment of the present invention.

FIG. 4 illustrates a front plan view of an exemplary card and exemplary display configurations of the display device according to exemplary embodiments of the present invention.

FIG. 5 illustrates a schematic block diagram of an exemplary card according to an embodiment of the present invention.

FIG. 6 illustrates a schematic block diagram of an exemplary card according to an embodiment of the present invention.

FIG. 7 illustrates a schematic block diagram of an exemplary card according to an embodiment of the present invention.

FIG. 8A illustrates a front plan view of an exemplary card according to an embodiment of the present invention.

FIG. 8B illustrates a side view of an exemplary card according to the exemplary embodiment of FIG. 8A.

FIG. 8C illustrates a side view of another exemplary card according to the exemplary embodiment of FIG. 8A.

FIG. 8D illustrates a side view of another exemplary card according to the exemplary embodiment of FIG. 8A.

FIG. 9 illustrates a schematic block diagram of an exemplary card according to an embodiment of the present invention.

FIG. 10 illustrates an exemplary card, vendor card reader, and dedicated card reader according to embodiments of the present invention.

FIGS. 11A and 11B illustrate an exemplary card and magnetic strip device according to embodiments of the present invention.

FIGS. 12A and 12B illustrate an exemplary card and magnetic strip reader device according to embodiments of the present invention.

### DETAILED DESCRIPTION OF THE EXEMPLARY EMBODIMENTS OF THE PRESENT INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Additionally, well-known elements of the invention will not be described in detail or will be omitted so as not to obscure the relevant details of the invention.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

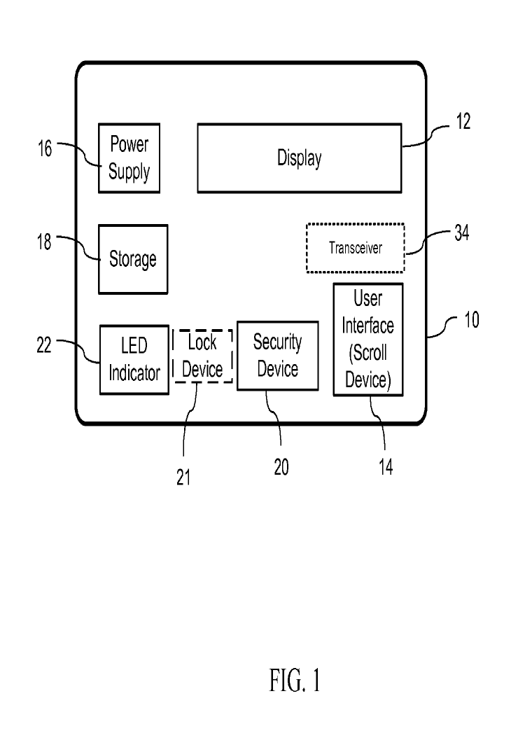

Referring now to the drawings, FIGS. 1-12B illustrate exemplary embodiments of a secure, universal, and interactive smart card device 10.

With reference to FIG. 1, an exemplary embodiment of a smart card 10 can include a display 12, an interface device such as scroll device 14, a power supply 16, and a storage unit 18. Another exemplary embodiment can include a security device 20, an LED indicator 22, such as a power indicator, status indicator, etc., and/or a transponder 34, such as a contactless transponder or the like. A more detailed description of each of these features of the exemplary embodiments will be provided with reference to the Figures below.

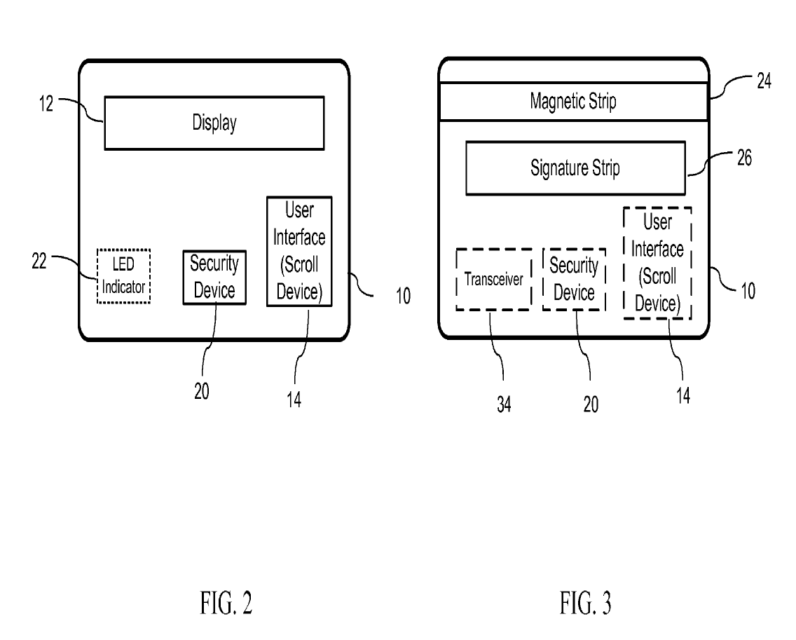

As shown in FIG. 2, an exemplary arrangement of a smart card 10 can include a display 12, a scroll device 14, and/or a security device 20. The card also may include one or more LED indicators 22 on the front face of the card 10. The rear face of the card 10 can include, for example, a magnetic strip 24 and a signature strip 26. In other embodiments, the scroll device 14 and/or the security device 20 can be disposed on the rear face of the card 10. The card 10 can include a transponder 34, such as a contactless transponder or the like.

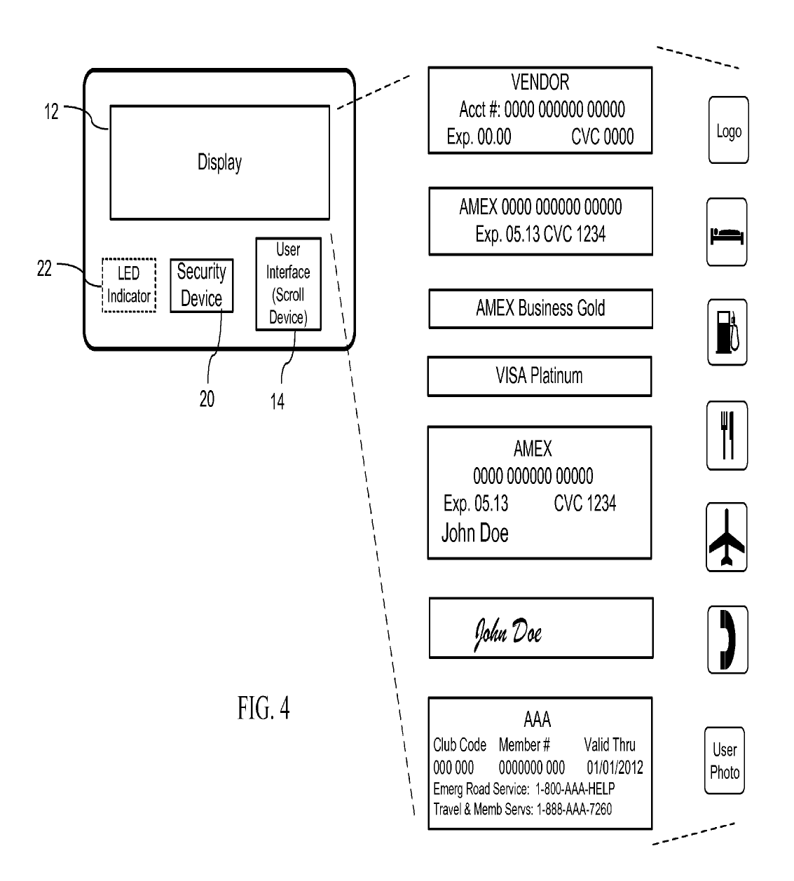

With reference to FIG. 4, the exemplary card can include a display 14 that can selectively display the particular vendor account or other information that has been selectively activated by the user. Additionally or alternatively, the display 14 can display one or more predetermined or programmable logos on the card 10 that are representative of the available vendor applications (e.g., credit card companies, vendor rebate cards, rewards cards, membership cards, or the like).

As shown in FIG. 4, the display 14 can be configured to display a variety of information that ordinarily is present on the front and/or back of a conventional vendor card, and a variety of formats or arrangements of such information. The display 14 also can be configured to display a variety of other information, such as identification information.

For example, the display 14 can be configured to display one or more of for example, a vendor name, vendor logo, card number (e.g., account number, membership number, rewards number, club code), expiration/valid date, card security information (e.g., Card Security Code (CSC), Card Verification Data (CVD), Card Verification Value (CVV or CVV2), Card Verification Value Code (CVVC), Card Verification Code (CVC or CVC2), Verification Code (V-Code or V Code), or Card Code Verification (CCV)). The display 14 can be configured to display one or more of, for example, one or more authorized card holder names, one or more authorized card holder signatures, one or more authorized card holder photographs, vendor emergency information or customer service information (e.g., lost or stolen card number, member services, emergency road service, etc.), type or class of card (e.g., credit card, debit card, rewards card, membership card, cash rebate card, platinum card, gold card, etc.), vendor or service logos, etc. The display 14 can be configured to display one or more category indicators (e.g., hotels/lodging, financial/bank or retail credit cards, restaurants, retail/department stores, grocery stores, wholesale warehouses, gas/oil companies, airlines, rail service, roadside assistance, emergency contacts, health insurance, auto insurance, or other types of insurance, wellness/cosmetic/beauty/hair/nail care providers/spas, building or site security access, personal identification, etc.).

The display 14, or a portion thereof, can be a liquid crystal display (LCD), for example, with or without a backlight, or with a light emitting diode light (LED) light source. In other embodiments, the display 14, or a portion thereof, can be formed by electronic paper (i.e., e-paper) that reflects ambient light.

The card 10 can include a single display 14 or a plurality of separate displays, for example, for dedicated functions.

The display 14 can be configured to display information in a manner that mimics or closely resembles the particular layout of one or more conventional cards, thereby providing a familiar, easy to use, and easily recognizable display format for both the consumer and the vendor. In other embodiments, the display 14 can be configured to display information in manner that has a standard format for all vendors, or for each category of vendor, etc.

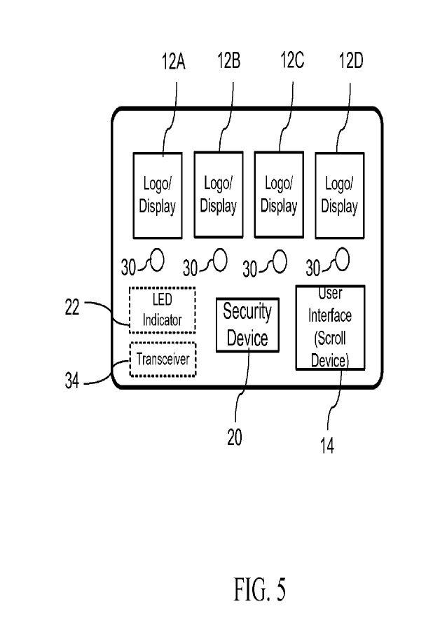

With reference to FIG. 5, in another embodiment, the card 10 can include one or more pre-programmed display devices or fixed (e.g., printed or embossed) logos/vendor names (e.g., 12A-12D). For example, the card 10 can include one or more permanent or programmable displays (e.g., 12A-12D) showing text or logos representative of a vendor with one or more corresponding indicators 30 (e.g., LED indicators). The indicators 30 can be illuminated to designate that the vendor identified in the corresponding display or identified by the corresponding logo/name (e.g., 12A-12D) has been selected and the card 10 is activated for this selected vendor. One of ordinary skill in the art will recognize that the card 10 is not limited to any particular number of displays, logo/displays, or indicators.

The card 10 may include a user interface device, for example, one or more scroll devices 14 or keys for scrolling through a list of available vendors, for example, listed in the display 12 or identified by a corresponding indicator 30. The scroll device 14 can include, for example, a pair of keys; one having an ‘UP’ arrow and the other having a ‘DOWN’ arrow. In another embodiment, the scroll device 14 can include a single key configured to select or navigate through a list of vendors in one direction or two directions. In other embodiments, the card 10 can include a plurality of input devices (not shown) configured to select a desired application from the plurality of stored applications on the card, such as a plurality of input devices each corresponding to a particular category of vendor or information.

In some cases, the scroll device 14 can be used by the consumer to select the particular vendor or application for a point of sale transaction. In other cases, the scroll device 14 can be used by the consumer to display information, for example, needed to make a purchase over the phone or on-line, such as card number,

With reference again to FIGS. 1-5, the card 10 can include a device or key for affirmatively selecting a particular application from the list of available vendors. In other embodiments, the card 10 can be configured such that the displayed vendor and card information represents the selected application of the card 10, thereby avoiding or reducing confusion or uncertainty on the part of the consumer or vendor regarding the selected vendor, type, account number, etc. of the card 10. In other embodiments, the security device 20 can be used to confirm the selected vendor application.

With reference again to FIGS. 1-5, the card 10 may include a security device 20 for verifying the identity of the card holder or authorized user. The security device 20 can include, for example, a biometric device, such as a finger or thumb print reader, retinal scanner, or other biometric scanner. The biometric devices are not limited to these examples and can include any device that can verify biometric information, such as face recognition, DNA, palm print, hand geometry, iris recognition, odor/scent, voice recognition, vein matching (i.e., biometric identification through the analysis of the patterns of blood vessels visible from the surface of the skin), etc. The securing device 10 can include other devices, such as devices that verify handwriting, typing rhythm, voice, etc.

In another embodiment, the secure, universal, interactive smartcard 10 can include a lock device or feature 21, which may be separately provided on the card 10 or integrated into the security device 20, that prevents the display 12 from displaying the selected card number and data, other non-selected card numbers or data, and/or other information stored on the smartcard 10, etc.

The lock device or feature 21 can include a hardware or software device (e.g., a hardware device or a device programmed to perform a locking function) that prevents one or more types or items of data (e.g., card numbers, expiration dates, security codes, user information, etc.) that is stored on the card 10 (e.g., on a memory or storage device 12, magnetic strip 24, etc.) from being displayed on the display 12 of the card 10, selectable for display on the display 12, selectable or downloadable from the card 10 (for example, by swiping a magnetic strip 24 of the card 10, transferring data using radio frequency, Bluetooth, near field communication (NFC), or other wireless means 34), and/or being displayed, read, downloaded from the card 10 in any way. In other embodiments, the lock device or feature 21 can include a hardware or software device (e.g., a hardware device or a device programmed to perform a locking function) that prevents one or more types or items of actual data (e.g., actual card numbers, expiration dates, security codes, user information, etc.) stored on the card 10 (e.g., in a storage device, magnetic strip, etc.), or downloaded to the card (e.g., via cloud services) from being displayed on the display 12 of the card 10, selectable for display on the display 12, selectable or downloadable from the card 10 (for example, by swiping a magnetic strip of the card, transferring data using radio frequency, Bluetooth, near field communication (NFC), or other wireless means), and/or being displayed, read, downloaded from the card in any way, and instead, permits only encrypted data, fake or so-called “dummy” or “ghost” data, or random data to be displayed, readable, or downloadable from the card 10 such that the actual user information remains confidential. For example, in an embodiment, the secure, universal, interactive smartcard 10 can include an encryption feature that encrypts any or all of the data stored on the smartcard 10 such that only encrypted information is displayed on the display 12 or downloadable, transferable, etc. from the smartcard 10, not the actual data stored on the card 10. In still other embodiments, some or all of the data stored on the card 10 (e.g., on a storage device 18, magnetic strip 24, or accessible, for example, via cloud services, etc.) can be stored in encrypted form. The encryption key for decrypting the data can be locally stored on the card 10, require user input or biometric confirmation (e.g., 20), or be remotely located from the card 10, such as at one or more of the credit card companies, card or membership issuer, etc., for example, for pairing the transaction with the user's account and/or authorizing the transaction, among other things. The lock device or feature 21 also can include a hardware or software device (e.g., a hardware device or a device programmed to perform a locking function) that prevents one or more types or items of data (e.g., card numbers, expiration dates, security codes, user information, etc.) or code (e.g., spyware, malware, etc.) from being transferred, programmed, or uploaded, etc. onto the smartcard 10.

The lock device feature can be, for example, an auto-lock device or feature 21 that automatically locks the card after the user selects the vendor application without additional user intervention. The lock device or feature 21 also can be activated by an affirmative step performed by the user, such as performing an additional swipe of the user's finger or thumb over the biometric fingerprint reader (e.g., 20) to lock the card 10. The lock feature 21 also can be a user selected option such that the user may select between an auto-lock feature and an affirmative step to lock the card 10. One of ordinary skill in the art will recognize that other lock devices and features are contemplated within the spirit and scope of the invention, such as entering a numeric or alphanumeric password, pin, or code to lock and/or unlock the card, data on the card, data displayed on the card, data readable from the card, data transferable from the card, and/or data transferable or programmable onto the card.

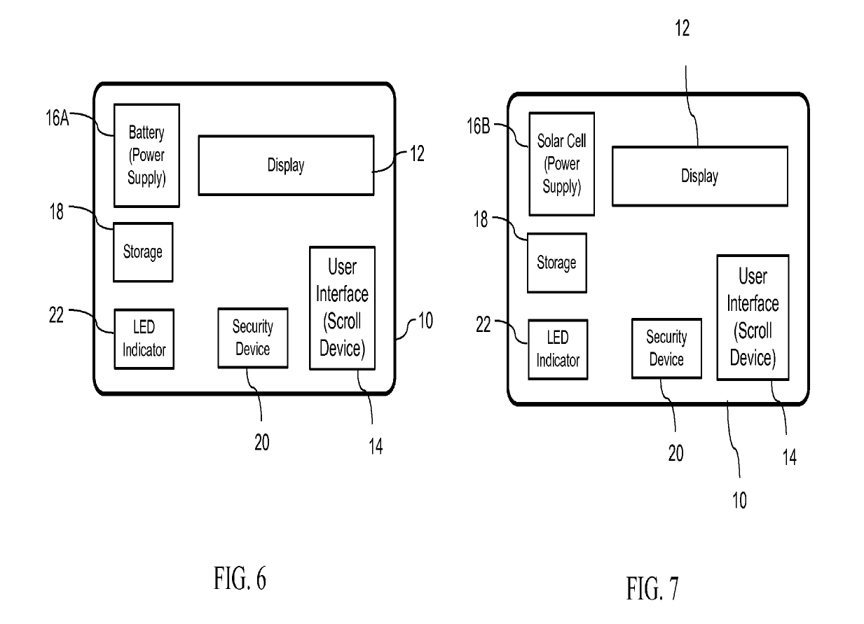

The card 10 can include an on-board power supply 16 for powering the display 12, user interface 12, security device 20, etc. For example, as shown in FIGS. 6 and 7, the card 10 can include a rechargeable or replaceable battery 16A or a solar cell 16B (e.g., organic solar cell that uses ambient light). Other embodiments of the card 10 can be powered by kinetic energy, for example, similar to a kinetic wrist watch. The card 10 may include a terminal or port or the like for connecting the card 10 to an external power source using a cord (e.g., power cord, USB cable, etc.) for operation of the device or charging of an on-board battery 16A.

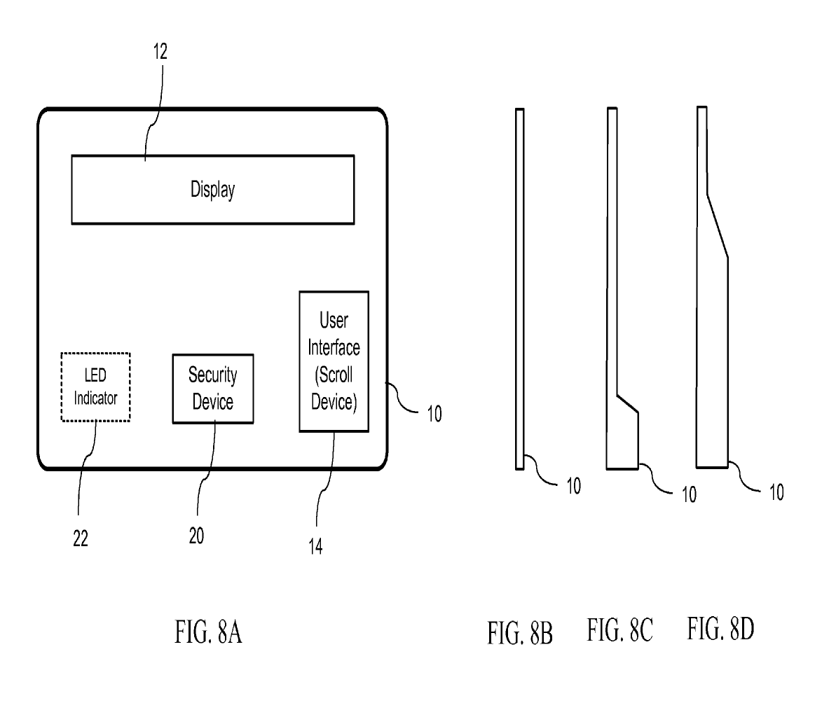

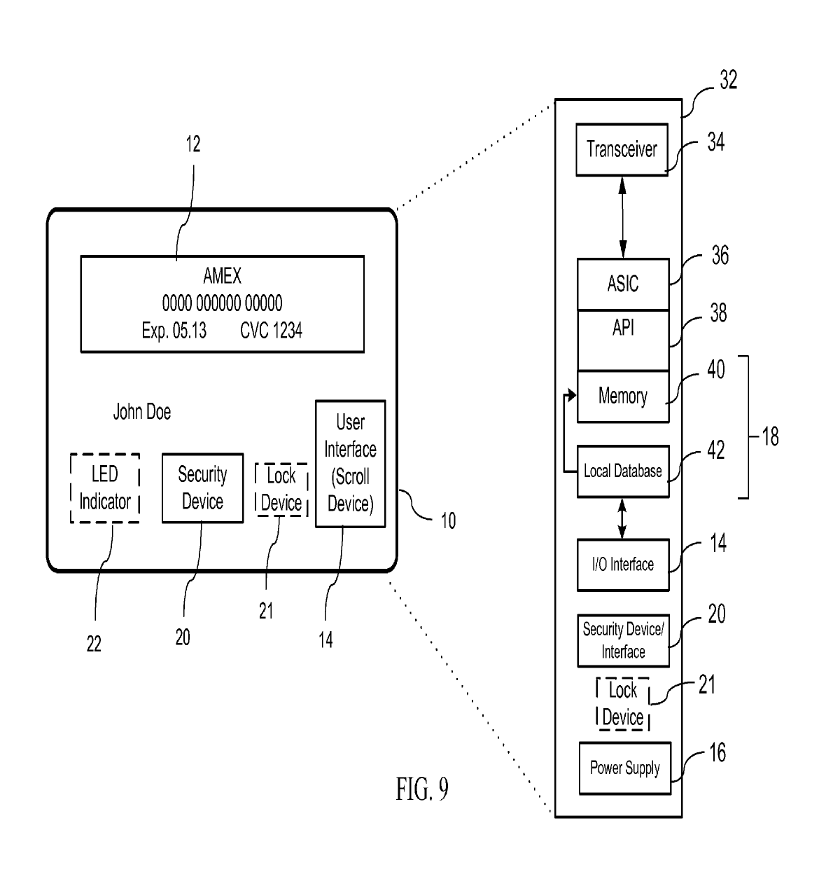

With reference to FIGS. 8A and 8B, the card 10 can have a side profile that is similar to a conventional credit card. In other embodiments, the card 10 can have a profile having a portion with a larger width that is configured to provide storage space within the card 10 or on the card 10, for example, for the interface (scroll device) 14, security device 20, power supply device 16, and/or storage device 18, etc., as shown in FIGS. 8C and 8D.

With reference for example to FIGS. 1, 6, 7, and 9, the card 10 can include a storage or memory device/unit 18 including read-only or random-access memory (RAM and ROM), EEPROM, flash cards, or any memory (e.g. 40) common to computer platforms. The card 10 also may include a local database 42 that can hold applications not actively used in memory 18. The local database 42 may be a flash memory cell, but can be any secondary storage device as is known in the art, such as magnetic media, EEPROM, optical media, tape, soft or hard disk, or the like. In another exemplary embodiment, the smartcard 10 can be configured such that data is stored using cloud services (i.e., data is stored on a remote server) rather than on the storage device 18 of the smartcard 10 and only transferred to the smart card 10, for example, upon being selected by the user.

Referring again to FIG. 9, the card 10 can include a transceiver 34 operably coupled to an application specific integrated circuit (“ASIC” 36), or other processor, microprocessor, logic circuit, or other data processing device. The ASIC 36 or other processor can execute the application programming interface (“API’) 38 layer that interfaces with any resident programs in the storage device 18 (e.g., memory 40, 42) of the card 10.

The internal platform 32 components also can be operably coupled to external interfaces of the card 10 such as input function buttons 14 (e.g., scroll devices) or security devices 20 (e.g., biometric devices) among other components, as is known in the art.

In operation, a user activates the card 10, for example, by using the security device 20. For example, the user may swipe a finger or thumb over a biometric fingerprint reader to authenticate the user's identity and activate the card 10. The user may then use the interface device 14, such as a scroll device, to navigate or scroll through a list of available vendor applications stored on the card 10. The display 12 of the card 10 can display a variety of information with respect to each vendor of a plurality of vendors stored in the storage device 18 of the card 10 (or accessible, for example, via cloud services), such as the vendor name, account number, etc., such that the user can verify which vendor application is being selected. When the desired vendor information is shown on the display 12, the user can select the vendor application, for example, by affirmatively selecting the vendor using a select feature (i.e., a discrete select feature), by again verifying the user's identity using the security device 20), or by simply using the card 10 in a manner similar to a conventional card 10, such as swiping the card 10, scanning the card 10, using a contactless feature (e.g., using the transceiver 34), such as an RFID feature, of the card 10, or the like. The user can switch to a different vendor application of the plurality of available vendor application stored in the storage device 18 of the card 10, such as a different rewards card 10 or credit card 10, by again activating the card 10 using the security device 20 and then selecting another vendor application out of the plurality of vendor applications stored in the storage device 18 on the card 10.

The vendor's card reader can scan or receive the account information for the particular selected vendor application in the same manner as if the user was using a conventional vendor card 10, and thus, may not require any additional or specialized equipment or processes on the vendor side. In other embodiments, the vendor can receive the account information from the smart card 10 using other means of communicating data, such as near field communication.

In another embodiment, a secure, universal, interactive credit card 10 according to the embodiments can be enrolled in a membership or service, such as a payment processing service.

In operation, similar to the aforementioned exemplary embodiment, a user can activate the card 10, for example, by using the security device 20. The user may then use the interface device 14, such as a scroll device, to navigate or scroll through a list of available vendor applications stored on the card 10. The display 12 of the card 10 can display a variety of information with respect to each vendor of a plurality of vendors stored in the storage device 18 of the card 10 (or accessible, for example, via cloud services), such as the vendor name, account number, etc., such that the user can verify which vendor application is being selected from the storage device 18 of the card 10 (or accessed, for example, via cloud services). When the desired vendor information is shown on the display 12, the user can select the vendor application, for example, by affirmatively selecting the vendor using a select feature (i.e., a discrete select feature), by again verifying the user's identity using the security device 20), or by simply using the card 10 in a manner similar to a conventional card 10, such as swiping the card 10, scanning the card 10, using a contactless feature, such as an RFID feature, near field communication, etc., of the card 10, or the like.

In this embodiment, the vendor's card reader can scan or receive the account information for the particular selected vendor application, for example, as an ordinary transaction using a card 10 issued by the payment processing service. The card 10 may transmit an account number for the payment processing service along with particular additional information, such as a suffix or prefix, which corresponds to the selected vendor application displayed on the card 10. This additional information can be used to inform the payment processing service of the appropriate account to charge the transaction. Again, this embodiment may not require any additional or specialized equipment or processes on the vendor side.

If the user desires to switch to a different vendor application of the plurality of available vendor application stored in the storage device 18 of the card 10, such as a different rewards card 10 or credit card 10, the user may again activate the card 10 using the security device 20 and then select another or different vendor application out of the plurality of vendor applications stored in the storage device 18 on the card 10 (or accessible, for example, via cloud services). In this embodiment, a vendor card reader can scan or receive the same account number for the payment processing service along with different additional information, such as a different suffix or prefix, which corresponds to the newly selected vendor application on the card 10. This additional information can be used to inform the payment processing service of the transaction for the newly selected vendor.

In this manner, this exemplary embodiment can provide a secure, universal, interactive credit card 10 that can be used by a consumer in any location and that permits a user to interact with the card 10 (e.g., directly with the card 10) to selectively attribute the use of the card 10 to a particular vendor out of a plurality of available vendors, after which the card 10 can be used by the consumer in the same manner as a conventional credit card 10, rebate card 10, rewards card 10, membership card 10, etc. The exemplary embodiments can provide consumer-based or card-based selectivity, as opposed to vendor-based selectivity or card reader-based selectivity. Additionally, this embodiment can maintain the information with respect to the vendor applications, such as account numbers, expiration dates, etc., entirely confidential from the vendor or anyone involved in the transaction, other than the payment processing service. The vendor may only be given knowledge of the user's account number for the payment processing service, but no information on the actual vendor account to which the transaction is being attributed.

In other embodiments, the card 10 may be configured to encrypt the account number, for example of the payment processing service, such that only an encrypted or ghost account number is known to the vendor. The encrypted account number may be based on the user's account number for the payment processing service and the selected vendor application and/or information particular to the card 10 or the authorized user such that the payment processing service can decrypt the transaction data and attribute the transaction to the particular application on the card 10 that was selected by that particular user.

In other embodiments, the card 10 may be configured to display 12 information with respect to one or more vendor applications on the card 10 (or accessible, for example, via cloud services). For example, if the user desires to make a telephone or on-line purchase, the user can activate the card 10, for example, by using the security device 20. The user may then use the interface device 14, such as a scroll device, to navigate or scroll through a list of available vendor applications stored on the card 10. The display 12 of the card 10 may display a variety of information with respect to each vendor of a plurality of vendors stored in the storage device 18 of the card 10 (or accessible, for example, via cloud services), such as the vendor name, account number, etc., such that the user can verify which vendor application is being selected from the storage device 18 of the card 10 (or accessed, for example, via cloud services). When the desired vendor information is shown on the display 12, the user can obtain the desired account information for the selected application and use the card 10 to make a telephone or on-line transaction in a manner similar to a conventional card 10.

In another example, if the user desires to access information with respect to a particular vendor application stored on the card 10 (or accessible, for example, via cloud services), such as health or auto insurance information, roadside assistance information, customer service information for a particular vendor, etc., the user can activate the card 10, for example, by using the security device 20. The user may then use the interface device 14, such as a scroll device, to navigate or scroll through a list of available vendor applications stored on the card 10. The display 12 of the card 10 may display a variety of information with respect to each vendor of a plurality of vendors stored in the storage device 18 of the card 10 (or accessible, for example, via cloud services), such as the vendor name, account number, etc., such that the user can verify which vendor application is being selected from the storage device 18 of the card 10 (or accessed, for example, via cloud services). When the desired vendor information is shown on the display 12, the user can obtain the desired account information for the selected application from the card 10 in a manner similar to reading the information from a conventional card 10.

Similarly, if the user desires to access information with respect to a particular vendor application stored on the card 10, such as an image of the user's signature, a photograph of the user, or other means for confirming the identity of the user, the user can activate the card 10, for example, by using the security device 20. The user may then use the interface device 14, such as a scroll device, to navigate or scroll through a list of available vendor applications or information stored on the card 10. The display 12 of the card 10 may be used by the user to display the desired identification information such that the user can show the identification information to verify or confirm the cardholder's identity to a vendor of a vendor application stored on the card 10, or to validate or confirm the cardholder's identify for other unrelated applications that are not associated with the applications stored on the card 10, such as to validate or confirm the cardholder's identify to law enforcement personnel, to obtain admission to a secure area (e.g., apartment or office building, parking garage, government facility), to complete unrelated transactions such as transactions using personal checks, to obtain admission to an event or concert requiring a ticket or reservation, etc.

The exemplary embodiments also include exemplary methods of providing consumer-based or card-based selectivity according to the aforementioned embodiments, as opposed to vendor-based selectivity or card reader-based selectivity.

In another embodiment, a secure, universal, interactive credit card 10 can be embodied or integrally formed with another electronic device, such as but not limited to, a smart phone, computer tablet device, iPad, electronic reader device (e-Reader), personal data assistant (PDA), computer notebook device, etc. Alternatively, an “add-on” device, such as an “add-on” magnetic strip device can be provided for a smart phone, computer tablet device, iPad, electronic reader device (e-Reader), personal data assistant (PDA), computer notebook device, etc.

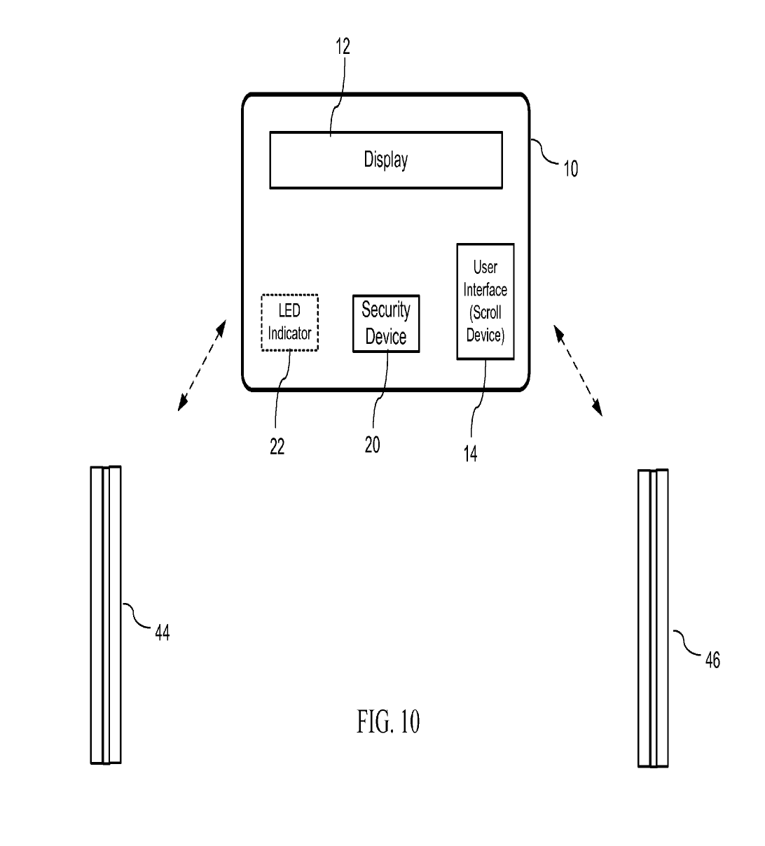

With reference to FIG. 10, an exemplary embodiment of the smartcard 10 can be configured to use a vendor's existing hardware 44. In other embodiments, the smartcard 10 can be configured to use only dedicated hardware 46 distributed by a smartcard provider. In still other embodiments, the smartcard 10 can be configured to selectively use a vendor's existing hardware 44 and/or dedicated hardware 46 distributed by a smartcard provider, thereby improving the universal use and/or acceptance of the smartcard at various vendors.

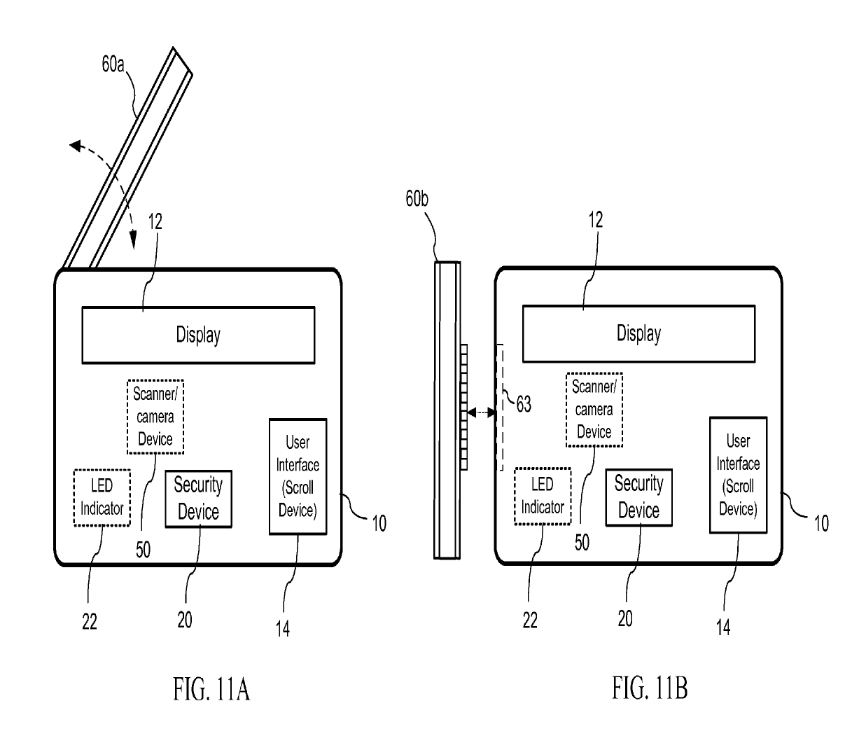

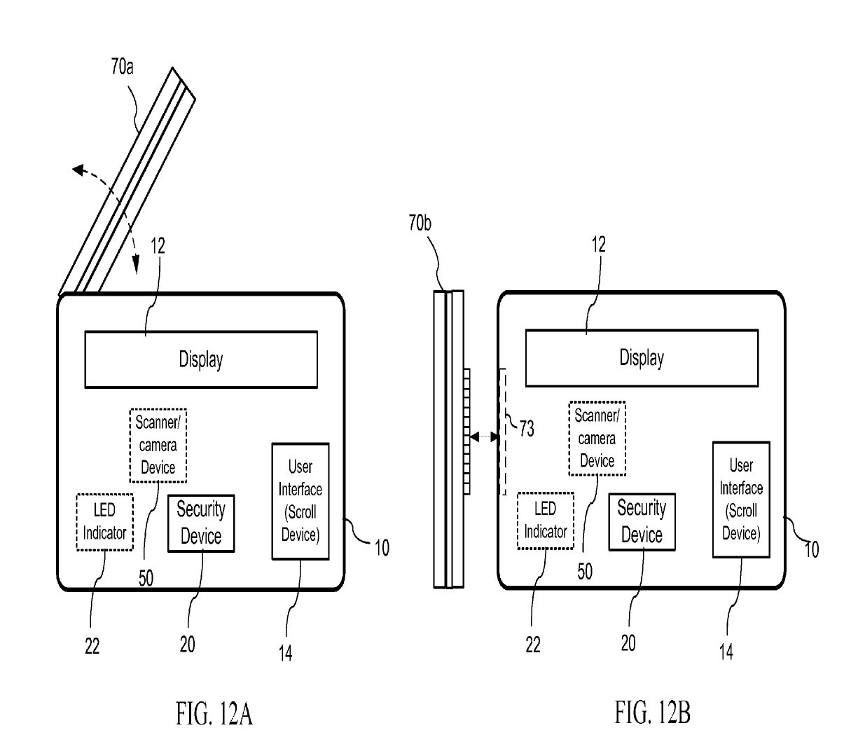

With reference to FIGS. 11A-12B, in other exemplary embodiments, the smartcard 10 can be configured such that a user can add data (such as credit card data, etc.) to the card 10 or remove data from the card 10. For example, the card 10 can include one or more of a scanner or camera device 50 (e.g., camera with scanning software), a magnetic strip reader, a radio frequency transmitter/receiver, Bluetooth transmitter/receiver, or other wireless communication device, a data cable (e.g., USB, etc.), or other means for programming or uploading/downloading data to/from the card 10 (e.g., via email, text, etc.).

With reference again to FIGS. 11A-11B, a magnetic strip can be permanently fixed to the smartcard 10, for example, as shown by the magnetic strip 24 in FIG. 3, or alternatively, can be a deployable magnetic strip device 60a that is deployed from the smartcard 10, for example, by pivoting, folding, or sliding the magnetic strip device 60a out from the card 10, or an “add-on” magnetic strip device 60b that is selectively connected to the smartcard 10, for example by connecting a terminal or connection of the “add-on” magnetic strip device 60b to a corresponding terminal or connection 63 on the card 10.

With reference again to FIGS. 12A-12B, the magnetic strip can be programmable by an on-board device of the card, or using another, external device. For example, the card 10 can include a magnetic strip reader that is permanently fixed to the smartcard 10, or alternatively, can be a deployable magnetic strip reader device 70a that is deployed from the smartcard 10, for example, by pivoting, folding, or sliding the magnetic strip reader device 70a out from the card 10. In another embodiment, the card 10 can include an “add-on” magnetic strip reader device 70b that is selectively connected to the smartcard 10, for example by connecting a terminal or connection of the “add-on” magnetic strip device 70b to a corresponding terminal or connection 73 on the card 10.

In an embodiment, the card 10 can include, for example, hardware that can program the magnetic strip 60a, for example, when the magnetic strip 60 is in the stored, folded, or retracted position within or adjacent to the card 10. For example, in operation, the user can select the desired card information to be used and then the hardware can program the magnetic strip 60a with the selected information, prior to deploying the magnetic strip 60a for swiping by the vendor.

In another embodiment, the magnetic strip 24, 60a, 60b can include a plurality of data or data sets (e.g., a plurality of card data, numbers, etc.), each of which being selectable using, for example, a key, code, password, decryption key, etc. in operation, a part or all of the data on the magnetic strip 24, 60a, 60b may be read by a vendor's card reader 44 (or alternatively, by a dedicated card reader device 46 provided by the smartcard issuer) and only the data corresponding to the user selected account, or key, code, password, decryption key, etc. provided by the user in the transaction, can be authorized for the transaction, decrypted for the transaction, etc.

In other embodiments, the card 10 can include a combination of a magnetic strip device 24, 60a, 60b and/or a magnetic strip reader device 70a, 70b.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a terminal. In the alternative, the processor and the storage medium may reside as discrete components in a terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A secure, universal, and interactive smart card device having a plurality of data items associated with a plurality of vendor cards, the smart card device comprising:
a body;
a storage device on the body, the storage device configured to one of store the plurality of data items associated with the plurality of vendor cards and access the plurality of data items associated with the plurality of vendor cards from a remote server;
a display on the body, the display configured to display an item of the plurality of data items associated with the plurality of vendor cards; and
a user interface device on the body, the user interface device configured to select the item of the plurality of data items stored on the storage device and control the display of the item on the display.

2. The smart card device of claim 1, further comprising:
a power supply on the body, the power supply for powering the display and the interface device.

3. The smart card device of claim 1, further comprising:
a security device on the body.

4. The smart card device of claim 3, further comprising:
a power supply on the body, the power supply for powering the display, the interface device, the security device, and the storage device.

5. The smart card device of claim 1, wherein the interface device is a scroll device.

6. The smart card device of claim 3, wherein the security device is a biometric device.

7. The smart card device of claim 1, further comprising a transponder for transmitting items stored on the storage device.

8. The smart card device of claim 1, further comprising a magnetic strip device.

9. The smart card device of claim 1, wherein the magnetic strip device is disposed on a surface of the smart card device.

10. The smart card device of claim 1, wherein the magnetic strip device is disposed on a surface of the smart card device that is opposite to the display.

11. The smart card device of claim 1, wherein the magnetic strip device is a removable magnetic strip device that is releasably coupled to the smart card device.

12. The smart card device of claim 1, wherein the magnetic strip device is deployable from the smart card device.

13. The smart card device of claim 1, wherein the display includes a visual indicator that identifies the item of the plurality of data items stored on the storage device.

14. The smart card device of claim 13, wherein the visual indicator is one of a passive indicator and an active indicator.

15. The smart card device of claim 1, further comprising a magnetic strip reader.

16. The smart card device of claim 15, wherein the magnetic strip reader is disposed on the smart card device.

17. The smart card device of claim 15, wherein the magnetic strip reader is a removable magnetic strip reader that is releasably coupled to the smart card device.

18. The smart card device of claim 15, wherein the magnetic strip reader is deployable from the smart card device.

19. The smart card device of claim 1, wherein the display includes a visual indicator that identifies the item of the plurality of data items stored on the storage device.

20. The smart card device of claim 19, wherein the visual indicator is one of a passive indicator and an active indicator.

21. The smart card device of claim 1, further comprising a lock device that prevents the display from displaying a selected item on the storage device.

22. The smart card device of claim 21, wherein the lock device includes an auto-lock device that automatically prevents the display from displaying the selected item on the storage device without user intervention.

23. The smart card device of claim 21, wherein the lock device includes a manual lock device that is user-selectable to prevent the display from displaying the selected item on the storage device without user intervention.

24. The smart card device of claim 1, wherein the storage device stores the items in an encrypted form.

25. The smart card device of claim 1, wherein the display device displays the items in an encrypted form.

26. The smart card device of claim 2, wherein the power supply is releasably secured to the body.

27. A secure, universal, and interactive smart card device having a plurality of data items associated with a plurality of vendor cards, the smart card device comprising:
a body;
a storage device on the body, the storage device configured to one of store the plurality of data items associated with the plurality of vendor cards and access the plurality of data items associated with the plurality of vendor card from a remote server;
means for outputting a data item of the plurality of data items associated with the plurality of vendor cards; and
a user interface device on the body, the user interface device configured to select the data item of the plurality of data items stored on the storage device and control the output of the data item by the means for outputting.

28. The smart card device of claim 27, wherein the means for outputting includes one of a display, a magnetic strip, a wired communication device, a wireless communication device, and a transponder.

29. A method of selecting a data item associated with a vendor card from a plurality of data items associated with a plurality of vendor cards using a secure, universal, and interactive smart card device, wherein the secure, universal, and interactive smart card device comprises a body; a storage device on the body, the storage device configured to one of store the plurality of data items associated with the plurality of vendor cards and access the plurality of data items associated with the plurality of vendor card from a remote server; means for outputting the data item of the plurality of data items associated with the plurality of vendor cards; and a user interface device on the body, the user interface device configured to select the data item of the plurality of data items stored on the storage device and control the output of the data item by the means for outputting, the method comprising:
selecting the data item of the plurality of data items one of stored on the storage device and accessible via a remote server using the user interface; and
outputting the selected data item using the means for outputting.
